(19) United States
(12) Patent Application Publication
(10) Pub. No.: US 2017/0161094 A1
(43) Pub. Date: Jun. 8, 2017

(54) MANUAL AND AUTOMATED TASK EXECUTION

(71) Applicant: Hewlett Packard Enterprise Development LP, Houston, TX (US)

(72) Inventors: Pablo Olive Gonzalez, Las Rozas (ES); Ignacio Aldama Perez, Alcobendas (ES); Ruben Rodriguez Lozano, Leon (ES); Mercedes Heras Cervino, Las Rozas (ES); Carlos Cano Alegre, Leon (ES); Fernando Autillo Gutierrez, Leon (ES); Ignacio Gomez-Lacazette Orejas, Las Rozas (ES)

(73) Assignee: Hewlett Packard Enterprise Development LP, Houston, TX (US)

(21) Appl. No.: 15/309,573

(22) PCT Filed: Jun. 20, 2014
(86) PCT No.: PCT/US14/43390

§ 371 Date: Nov. 8, 2016

(51) Int. Cl. G06F 9/46; G06F 9/44

(52) U.S. Cl. CPC G06F 9/46; G06F 9/4443

(57) ABSTRACT

Example implementations relate to manual and automated task execution in a process. For example, a computing device may include a processor. The processor may initiate a process having a manual task and an automated task, the process being associated with process definitions stored in a database. The processor may send, from the database, a manual process definition associated with the manual task to a new entry in the database and an automated process definition associated with the automated task to an automated process queue. The processor may execute the automated task based on the automated process definition in the automated process queue and may execute the manual task using the manual process definition in the new entry of the database. The execution of the manual task may generate a user interface to receive data associated with the manual task.

### BACKGROUND

Business entities typically utilize processes that may be executed to perform certain business-related operations. For example, a business supplying products to customers may utilize a particular process for shipping the product to a customer in an organized manner. To keep up with changing markets and customer needs, these processes may often times need to be updated, redesigned, and/or modified.

### BRIEF DESCRIPTION OF THE DRAWINGS

Some examples of the present application are described with respect to the following figures:

FIG. 1 is a block diagram of an example computing device for manual and automated task execution;

FIG. 2 is a flowchart illustrating an example method of manual and automated task execution;

FIG. 3 is a diagram of an example process and its related tasks, conditions, variables, and parameters;

FIG. 4 is a diagram of an example service activation process associated with manual tasks;

FIG. 5 is a diagram of example user interfaces for designing and implementing a process using process definitions;

FIG. 6 is a diagram of an example user interface displaying form definitions for a manual task user interface associated with a manual task;

FIG. 7 is a diagram of an example manual task user interface associated with a manual task based on the form definitions shown in FIG. 6; and

FIG. 8 is a diagram of an example user interface displaying process tracking.

### DETAILED DESCRIPTION

As described above, business entities utilize processes for performing business-related operations. Some processes may be manual operations with tasks that may incorporate human involvement, while other processes may be automated operations that may be performed by a computing device without incorporating human involvement. While automated tasks may be performed by a computing device, it may be difficult to incorporate operations that involve manual tasks. For example, if a business automates a process that creates shipping labels for customers who order a product, the automated process may not be able to account for a change to a shipping address if a customer decides to change the shipping location after the automated process has started.

To accommodate both manual and automated tasks, a global process manager may be used to manage tasks such that manual and automated tasks may both be performed in a process through the use of a condensed database model. The condensed database of the global process manager may contain data associated with concurrently performing manual and automated tasks within processes. For example, the condensed database may include a definitions table, an instance table, and a graphical user interface (GUI) definitions table. The definitions table may include data defining manual and automated tasks that may be performed in a process. The instance table may include data associated with task definitions and task results during runtime. The GUI definitions table may include data associated with GUIs that may be used as part of a manual task (e.g., inputting customer information received over the phone). The global process manager may be used to manage any tasks for any business-related processes, such as telecommunication fulfillment processes (e.g., cell phone activation, internet service action, etc.), credit card activation, a supermarket buying products from suppliers, medical processes, ordering processes, and the like. The global process manager allows processes to jump into multiple steps in a process at any time such that several tasks may be performed independently at any speed, independent of other tasks. The global process manager allows for reusability of data associated with processes through the use of the condensed database, ease of use for an operator operating business-related processes, traceability of the history and the progress of a process, and flexibility of a process by allowing modifications at any time.

When a manual task within a process is executed, a GUI may be automatically generated using a form generation module. The GUI may provide task configuration for an operator and may allow the operator to input information related to the manual task. Examples of manual tasks may include an operator inputting a new customer's information into a database such that a new cell phone may be ordered for the customer, a revision to a previously-ordered service based on a request from a customer, calling a customer upon discovery of a lost order, and any tasks related to revisions, approval, error handling, choice selection, and the like.

When an automated task within a process is executed, the automated task may be sent to an automated task queue and may be processed based on a configured priority of the automated task queue. In some examples, certain automated tasks may be assigned to specific queues based on privileges associated with each queue. Because automated tasks are performed by one or more computing devices, these tasks may be paused, blocked, and/or resumed. Examples of automated tasks may include activation of an ordered phone upon receipt of information related to the order, creation of a shipping label, and the like.

When creating a particular business-related process, a designer may implement a design of the process using the global process manager. For example, a designer may design the process in any desired manner (e.g., hand-drawn, a drawing application for designing a process, etc.). The designed process may be used to create a related set of process definitions in the global process manager to define the tasks and conditions within the process. The process definitions may be stored in the definitions table of the condensed database. The designer may also create a set of GUI definitions defining any GUIs that may be used to perform a manual task. The GUI definitions may be stored in the GUI definitions table of the condensed database. The process may be implemented through the global process manager using the process definitions and the GUI definitions.

When a process is executed, the process definitions and the GUI definitions related to the process may be accessed and copied from the definitions table of the database to the instance table of the database. Automated tasks within the process may be loaded to a particular automated task queue (e.g., based on privileges of each automated task queue). The automated task queue may perform the automated tasks based on the configured priority of the automated task queue. In some examples, if the automated task queue is empty, the automated task queue may query the instance table periodically for additional tasks to perform. When a manual task within the process is started, any related GUIs may be generated and used to provide information related to the manual task. The manual task may be performed using the GUI definitions and the process definitions copied to the instance table of the database. Manual tasks are stored in the database as pending tasks until execution (e.g., until a user interacts with any GUIs associated with a manual task). As such, processor memory is not used until execution of the pending task, saving memory bandwidth and reducing performance issues for processes with multiple manual tasks.

Processes may be tracked at any time during execution. Process tracking may indicate the progress of each task within a process. The progress of each task may be indicated using an identifier indicating the status of each task. For example, an indicator may indicate statuses such as a task that has been executed successfully, a task that was executed with an error, a task that has not yet been executed, a task that is being executed, a task that is pending, and the like.

Processes managed by the global process manager may be modified at any time. For example, a process definition, GUI definition, or a process instance may be modified at any time, such as before or during execution of a process. When changes are made during runtime, the modified expression may be stored in the instance table of the database and may be evaluated to perform the modified expression. In some examples, if a process definition is modified during runtime, the modified process definition may be stored in the instance table of the database while the original process definition remains unchanged in the process definitions table of the database, allowing tracking of changes and comparison between modifications and the initial process definition. In some examples, when changes are made, the changes are stored with indications of the changes that were made and which user made the changes. Changes made during runtime may be made while the process is being executed and without having to restart the process.

In some examples, the global process manager may be implemented within the context of a director operating in a network functions virtualization (NFV) networking architecture. The director may automatically arrange, coordinate, and manage complex computer systems, middleware, and services associated with a business entity by using virtualization of related technologies (e.g., through the use of virtual machines running various software and processes). For example, the NFV director may arrange, coordinate, and manage networked computing devices for telecommunications entities, such as communications service providers (CSPs), network equipment providers (NEPs), and the like, to create a dynamic network environment for delivering and providing telecommunications services. The NFV director may use the global process manager to manage telecommunications service-related tasks such that manual and automated tasks may both be performed in a process using the condensed database model. For example, an NFV director managing internet services that may be provided to a customer may use the global process manager to perform automated and manual tasks relating to receiving a service order from a customer, providing the service to the customer, configuring and activating the service, managing and maintaining the service, and the like.

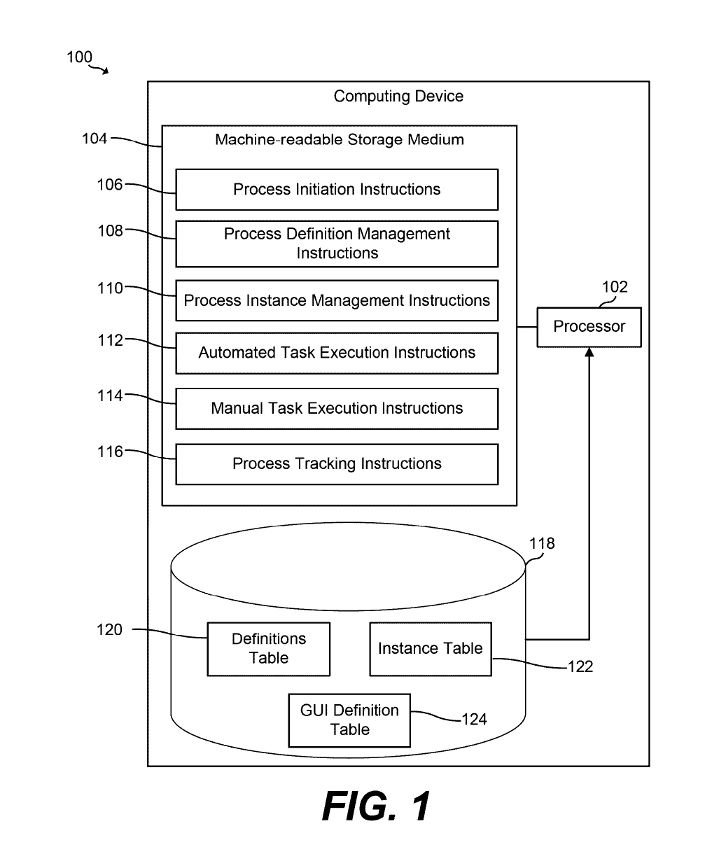

Referring now to the figures, FIG. 1 is a block diagram of an example computing device 100 for manual and automated task execution. As used herein, a manual task is a task in a process that is not fully performed or completed automatically by one or more computing devices alone. For example, a manual task may utilize information that is provided by an operator and may not be fully performed or completed automatically by a computing device alone until the information is inputted by the operator (e.g., taking a telephone order from a customer who wishes to order a product). Additionally, as used herein, an automated task is a task in a process that is fully performed or completed automatically by one or more computing devices. For example, an automated task may include automatically creating a shipping label populated with customer information once the customer information is inputted using a prior manual task.

Computing device 100 may be, for example, a web-based server, a local area network server, a cloud-based server, a notebook computer, a desktop computer, an al-in-one system, a tablet computing device, a mobile phone, an electronic book reader, or any other electronic device suitable for manual and automated task execution. Computing device 100 may include a processor 102, a machine-readable storage medium 104, and database storage 118.

Processor 102 may be a central processing unit (CPU), a semiconductor-based microprocessor, and/or other hardware devices suitable for retrieval and execution of instructions stored in machine-readable storage medium 104. Processor 102 may fetch, decode, and execute instructions 106, 108, 110, 112, 114, and 116 to control and execute processes having manual and automated tasks. Processor 102 may control and execute processes using the definitions table 120, instance table 122, and GUI definition table 124 stored in database storage 118. As an alternative or in addition to retrieving and executing instructions using the tables in database storage 118, processor 102 may include at least one electronic circuit that includes electronic components for performing the functionality of instructions 106, 108, 110, 112, 114, 116, or a combination thereof.

Machine-readable storage medium 104 may be any electronic, magnetic, optical, or other physical storage device that contains or stores executable instructions. Thus, machine-readable storage medium 104 may be, for example, Random Access Memory (RAM), an Electrically Erasable Programmable Read-Only Memory (EEPROM), a storage device, an optical disc, and the like. In some examples, machine-readable storage medium 104 may be a non-transitory storage medium, where the term “non-transitory” does not encompass transitory propagating signals. As described in detail below, machine-readable storage medium 104 may be encoded with a series of processor-executable instructions 106, 108, 110, 112, 114, and 116 for initiating a process having a manual task and an automated task associated with process definitions stored in definitions table 120 of database storage 118, sending a manual process definition associated with the manual task from definitions table 120 to a new entry in database storage 118, sending an automated process definition associated with the automated task from definitions table 120 to an automated process queue, executing the automated task based on the automated process definition in the automated process queue, and executing the manual task using the manual process definition in the new entry of database storage 118, where execution of the manual task generates a user interface to receive data associated with the manual task.

Process initiation instructions 106 may initiate a process based on a request to begin the process. For example, process initiation instructions 106 may receive an indication to initiate a particular process.

Process definition management instructions 108 may manage, store, access, modify, and control process definitions associated with manual and automated tasks of a process. Process definition management instructions 108 may access and send process definitions associated with the initiated process from the definitions table 120 to the instance table 122. The process definition management instructions 108 may send any manual tasks of the process to a new entry in database storage 118 and may send any automated tasks of the process to an automated process queue.

Process instance management instructions 110 may manage, store, access, modify, and control process instances stored in the instance table 122 of database storage 118. Process instance management instructions 110 may copy process definitions from the definitions table 120 for any processes that have been initiated.

Automated task execution instructions 112 may manage and control execution of automated tasks in the automated task queue. Automated task execution instructions 112 may manage privileges associated with automated task queues and may assign certain automated tasks to a particular queue based on the privileges. Automated task execution instructions 112 may process automated tasks based on a configured priority associated with the queue. In some examples, automated task execution instructions 112 may query the instance table 122 for automated tasks when the automated task queue is empty.

Manual task execution instructions 114 may manage and control execution of manual tasks that may be pending in database storage 118. Manual task execution instructions 114 may access a pending manual task when the task is ready to be performed and may perform the task based on the process definitions associated with the manual task. In some examples, performing a manual task may include generating a GUI associated with the manual task. Manual task execution instructions 114 may generate the GUI using the GUI definition stored in GUI definition table 124 of database storage 118.

Process tracking instructions 116 may manage and control tracking of a process. Process tracking instructions 116 may determine the statuses of tasks within a process and may provide indicators indicated the statuses of each task. In some examples, the indicators may be colors indicating a particular status (e.g., successfully executed=green, executed with an error=red, not yet executed=black, pending execution or currently executing=blue, etc.).

As described above, database storage 118 may include definitions table 120, instance table 122, and GUI definition table 124. Definitions table 120 of database storage 118 may include data defining manual and automated tasks that may be performed in a process. These process definitions may be accessed, modified, and/or deleted. Instance table 122 of database storage 118 may include data associated with task definitions and task results during runtime. Instance table 122 may include definitions copied from definitions table 120, definitions changed during runtime, and the like. GUI definition table 124 of database storage 118 may include data associated with GUIs that may be used as part of a manual task.

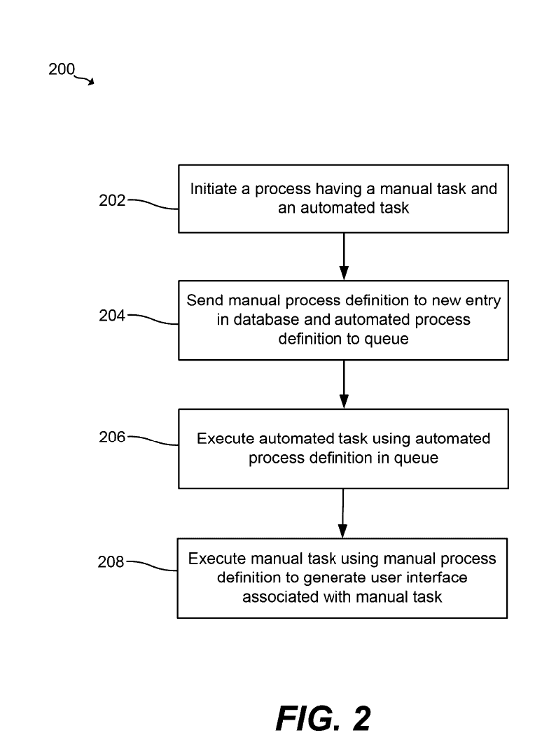

FIG. 2 is a flowchart illustrating an example method 200 of manual and automated task execution. Method 200 may be implemented using computing device 100 of FIG. 1.

Method 200 includes, at 202, initiating a process having a manual task and an automated task. The process is associated with process stored in a database, such as in database storage 118 of FIG. 1, for example.

Method 200 also includes, at 204, sending a manual process definition associated with the manual task to a new entry in the database and sending an automated process definition associated with the automated task to an automated process queue.

Method 200 also includes, at 206, executing an automated task using the automated process definition in the automated task queue.

Method 200 also includes, at 208, executing a manual task using the manual process definition in the new entry of the database to generate a user interface associated with the manual task. The user interface may be used to receive data associated with the manual task.

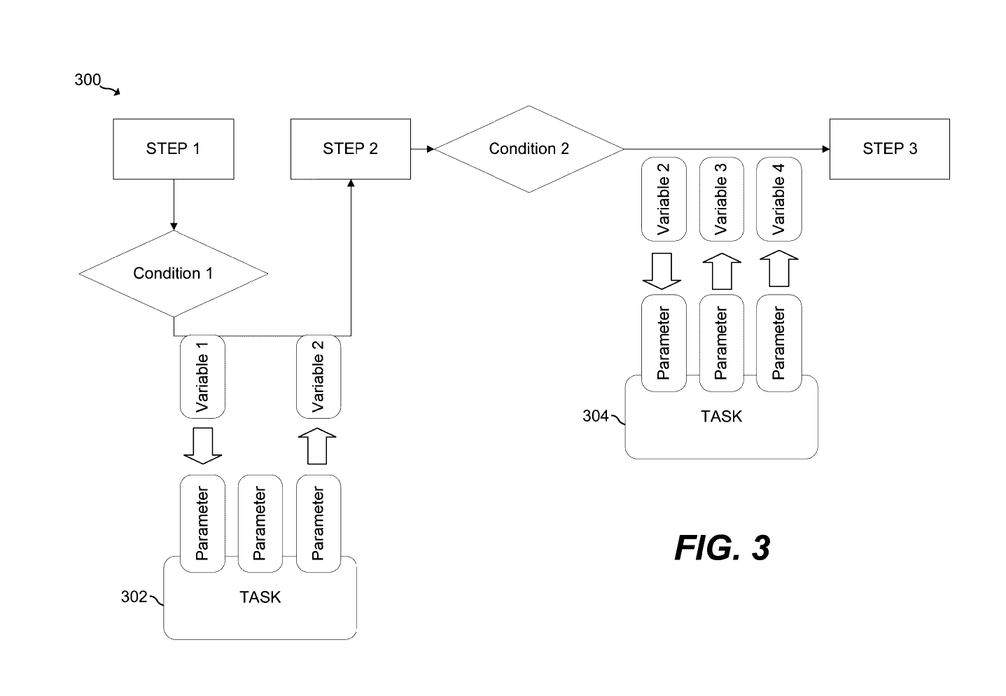

FIG. 3 is a diagram of an example process 300 and its related tasks, conditions, variables, and parameters. Process 300 includes Step 1, Step 2, and Step 3. Each step dynamically evaluates the conditions defined for each step such that, if the conditions are changed during runtime, Process 300 may evaluate the new modified expression. The transition from Step 1 to Step 2 may be performed upon fulfillment of Condition 1. Once Condition 1 has been fulfilled, task 302 may be performed. Task 302 may be a manual or an automated task. Task 302 may be performed based on certain parameters and based on Variable 1. The parameters associated with Task 302 may be populated with Variable 1 to produce Variable 2. In some examples, Variable 1 may be a result from a previous task. Performing Task 302 may result in the calculation of Variable 2, and Step 2 of process 300 may begin. The transition from Step 2 to Step 3 may be performed upon fulfillment of Condition 2. Once Condition 2 has been fulfiled, task 304 may be performed based on certain parameters and based on Variable 2. The parameters associated with Task 304 may be populated with Variable 2 to produce Variable 3 and Variable 4. In some examples, Variable 2 may be a result from a previous task (e.g., Task 302). Task 304 may be a manual or an automated task. Performing Task 304 may result in the calculation of Variable 3 and Variable 4, and Step 3 of the process may begin.

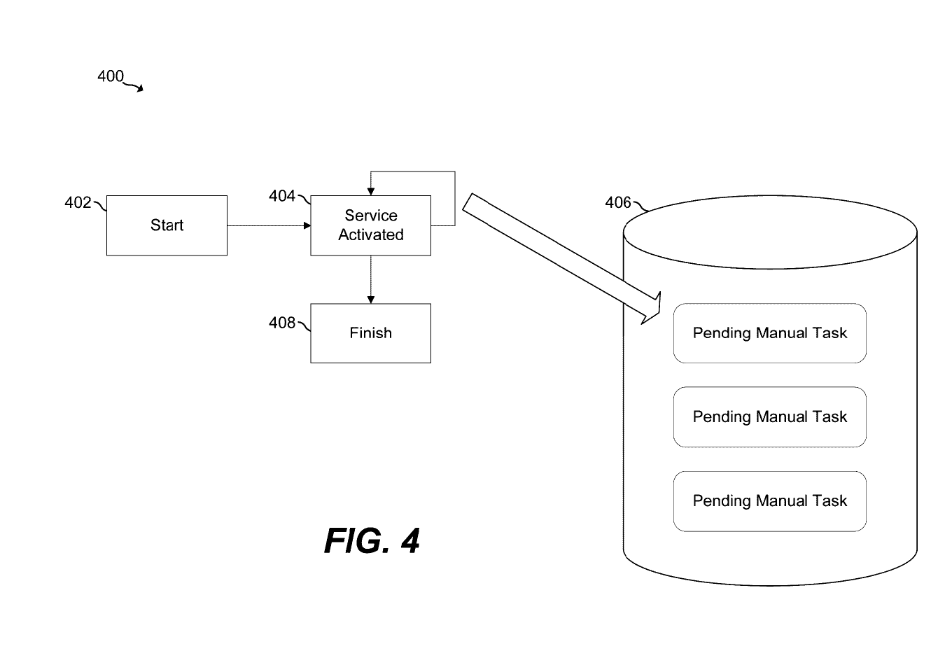

FIG. 4 is a diagram of an example service activation process 400 associated with manual tasks. The manual tasks may be stored as pending tasks in database 406. When process 400 is initiated at step 402, the service activation task may be performed. At step 404, a determination regarding whether the service has been activated may be made. If the service has been activated, process 400 may be completed at step 408. If an error in activation is determined at step 404, or if the activation has not yet completed at step 404, the task of completing activation using the pending manual tasks in database 406 may continue until successful.

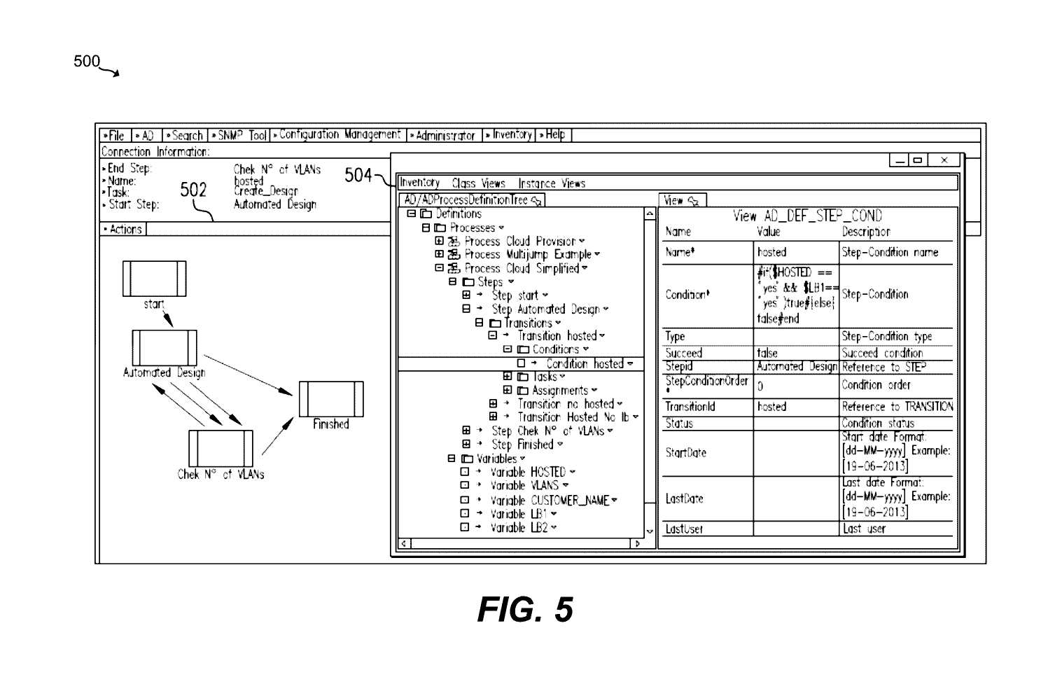

FIG. 5 is a diagram of example user interfaces 500 for designing and implementing a process using process definitions. User interface 502 may display a diagram of the process being designed, including displaying the steps in the process. User interface 504 may be used to create, access, and/or modify process definitions associated with the process shown in user interface 502.

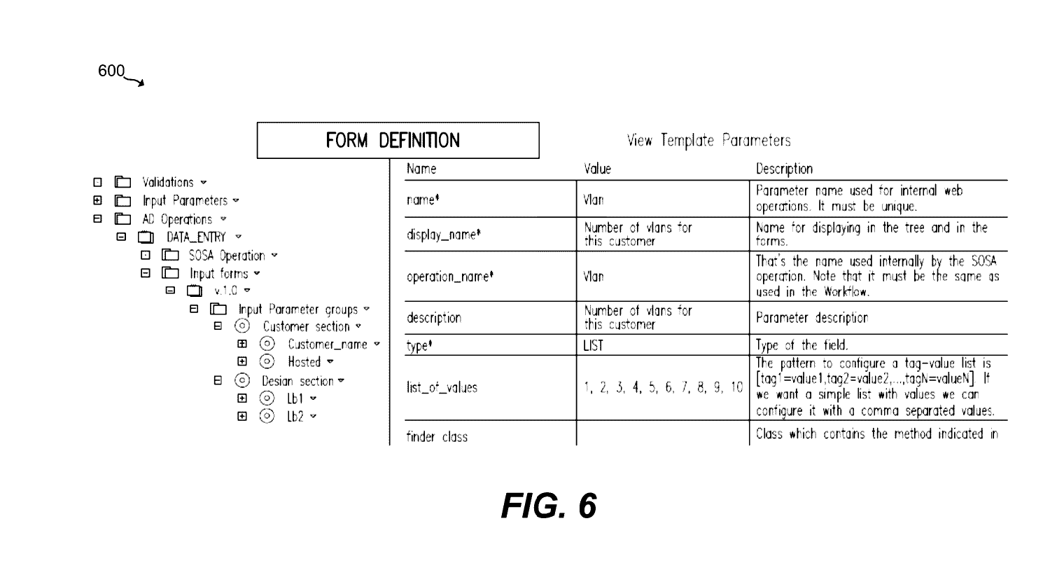

FIG. 6 is a diagram of an example user interface 600 displaying form definitions for a manual task user interface associated with a manual task. User interface 600 shows definitions available for creating and generating a manual task user interface that may be used to perform a particular manual task. The form definitions shown in user interface 600 include definitions associated with a manual task of inputting customer information for a customer ordering a virtual local area network (VLAN).

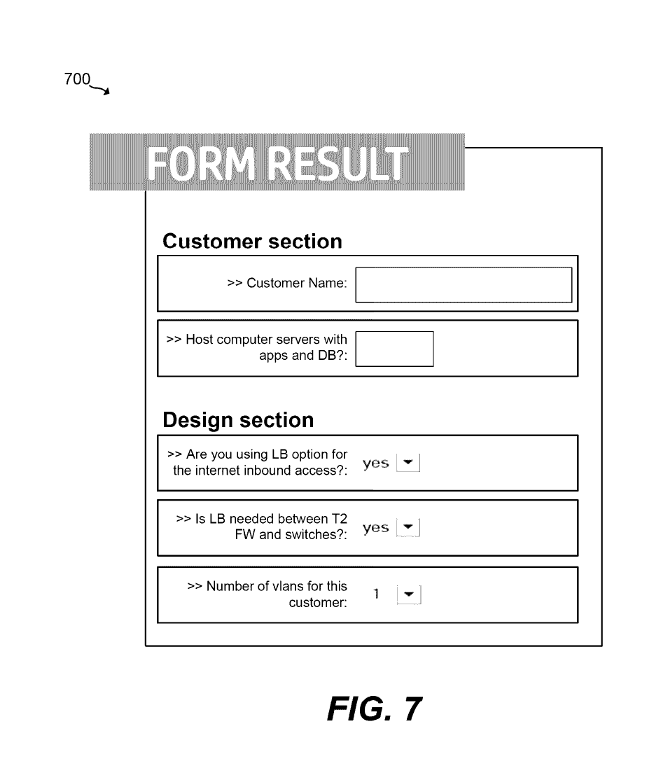

FIG. 7 is a diagram of an example manual task user interface 700 associated with a manual task based on the form definitions shown in FIG. 6. The manual task user interface 700 includes fields that may be used to input data associated with a customer and the customer's service order. The manual task user interface 700 may be used by any suitable person capable of completing the manual task of inputting customer data. For example, data may be inputted into the manual task user interface 700 by an operator taking a service order from a customer over the phone, by the customer requesting access online through a website, and the like.

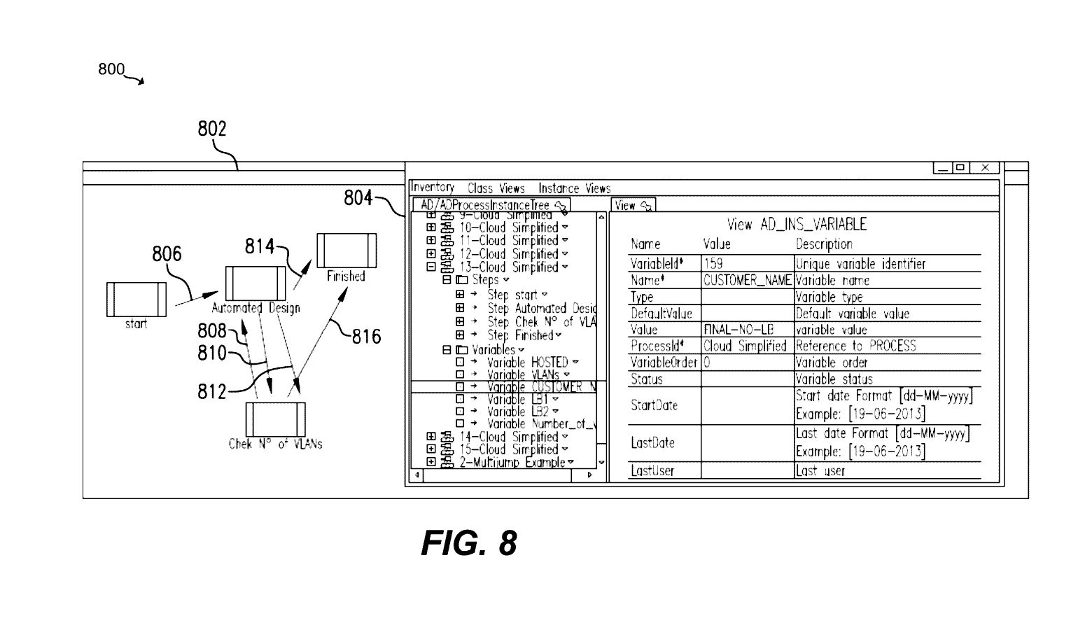

FIG. 8 is a diagram of an example user interface 800 displaying process tracking. User interface 802 may display a diagram of the process and the statuses of each task in the process. User interface 804 may display the corresponding process definitions associated with the process. When a request to track the process is received, the global process manager may determine the statuses of each task within the process and may display indications of the statuses of each task. For example, task arrow 806 may be displayed in green, indicating that the corresponding task has been executed successfully. Task arrow 808 may be displayed in blue, indicating that the corresponding task is pending or is currently being executed. Task arrow 810 may be displayed in black, indicating that the corresponding task has not yet been executed. Task arrow 812 may be displayed in red, indicating an error that occurred during execution of the corresponding task. Task arrow 814 and task arrow may also be displayed in black, indicating that the corresponding tasks have not yet been executed.

Examples provided herein (e.g., methods) may be implemented in hardware, software, or a combination of both. Example systems may include a controller/processor and memory resources for executing instructions stored in a tangible non-transitory medium (e.g., volatile memory, non-volatile memory, and/or machine-readable media). Non-transitory machine-readable media can be tangible and have machine-readable instructions stored thereon that are executable by a processor to implement examples according to the present disclosure.

An example system can include and/or receive a tangible non-transitory machine-readable medium storing a set of machine-readable instructions (e.g., software). As used herein, the controller/processor can include one or a plurality of processors such as in a parallel processing system. The memory can include memory addressable by the processor for execution of machine-readable instructions. The machine-readable medium can include volatile and/or non-volatile memory such as a random access memory (“RAM”), magnetic memory such as a hard disk, floppy disk, and/or tape memory, a sold state drive (“SSD”), flash memory, phase change memory, and so on.

What is claimed is:

1. A computing device comprising:
a processor to:
initiate a process having a manual task and an automated task, the process being associated with process definitions stored in a database;
send, from the database, a manual process definition associated with the manual task to a new entry in the database and an automated process definition associated with the automated task to an automated process queue;
execute the automated task based on the automated process definition in the automated process queue; and
execute the manual task using the manual process definition in the new entry of the database, wherein execution of the manual task generates a user interface to receive data associated with the manual task.

2. The computing device of claim 1, wherein the user interface is generated using a user interface definition stored in the database.

3. The computing device of claim 1, wherein the processor is further to:
receive, during runtime of the process, a modification to a process definition associated with the process;
provide the modification to the database; and
execute the modification to the process definition during the runtime of the process.

4. The computing device of claim 1, wherein the processor is further to:
determine runtime statuses of the manual task and the automated task; and
provide status indicators indicating the runtime statuses of the manual task and the automated task.

5. The computing device of claim 4, wherein the status indicators indicate a completed task, a pending task, a task error, or an uncompleted task.

6. The computing device of claim 1, wherein the computing device is one of a plurality of networked computing devices managed by a network functions virtualization director.

7. A method comprising:
receiving, by a computing device, an indication to begin a process having a manual task and an automated task, the process being associated with process definitions stored in a database;
copying, by the computing device, a manual process definition associated with the manual task to a new entry in the database and an automated process definition associated with the automated task to an automated process queue;
performing, by the computing device, the automated task based on the automated process definition in the automated process queue; and
performing, by the computing device, the manual task using the manual process definition in the new entry of the database, wherein performing the manual task comprises:
generating a user interface; and
receiving, using the user interface, data associated with the manual task.

8. The method of claim 7, further comprising:
receiving, during runtime of the process, a modification to a process definition associated with the process;
providing the modification to the database; and
performing the modification to the process definition during the runtime of the process.

9. The method of claim 7, further comprising:
determining runtime statuses of the manual task and the automated task; and
providing status indicators indicating the runtime statuses of the manual task and the automated task.

10. The method of claim 9, wherein the status indicators indicate a completed task, a pending task, a task error, or an uncompleted task.

11. The method of claim 7, wherein the computing device is one of a plurality of networked computing devices managed by a network functions virtualization director.

12. A non-transitory machine-readable storage medium storing instructions that, if executed by at least one processor of a computing device, cause the computing device to:
initiate a process having a manual task and an automated task, the process being associated with process definitions stored in a database;
copy, from the database, a manual process definition associated with the manual task to a new entry in the database;
copy, from the database, an automated process definition associated with the automated task to an automated process queue;
execute the automated task based on the automated process definition in the automated process queue; and
execute the manual task using the manual process definition in the new entry of the database, the execution of the manual task providing a user interface to receive data associated with the manual task.

13. The non-transitory machine-readable storage medium of claim 12, wherein the instructions, if executed by the at least one processor, further cause the computing device to:
receive, during runtime of the process, a modification to a process definition associated with the process;
provide the modification to the database; and
execute the modification to the process definition during the runtime of the process.

14. The non-transitory machine-readable storage medium of claim 12, wherein the instructions, if executed by the at least one processor, further cause the computing device to:
determine runtime statuses of the manual task and the automated task; and
provide status indicators indicating the runtime statuses of the manual task and the automated task.

15. The non-transitory machine-readable storage medium of claim 14, wherein the status indicators indicate a completed task, a pending task, a task error, or an uncompleted task.
